(19) United States
(12) Patent Application Publication
(10) Pub. No.: US 2024/0051447 A1
(43) Pub. Date: Feb. 15, 2024

(54) VEHICLE HEADREST ASSEMBLY WITH DEPLOYABLE SPEAKER MODULES

(71) Applicant: HARMAN INTERNATIONAL INDUSTRIES, INCORPORATED, Stamford, CT (US)

(72) Inventors: David MOSSINGTON, Rochester, MI (US); Riley WINTON, Opelika, AL (US); Tingli CAI, Ann Arbor, MI (US); Chris LUDWIG, Bloomfield Hills, MI (US)

(73) Assignee: HARMAN INTERNATIONAL INDUSTRIES, INCORPORATED, Stamford, CT (US)

(21) Appl. No.: 18/267,254

(22) PCT Filed: Dec. 30, 2021
(86) PCT No.: PCT/US2021/065787

§ 371 Date: Jun. 14, 2023

Related U.S. Application Data
(60) Provisional application No. 63/132,577, filed on Dec. 31, 2020.

(51) Int. Cl. B60N 2/879; H04R 5/02; H04R 3/12; H04R 1/32; H04R 1/02

(52) U.S. Cl. CPC B60N 2/879; H04R 5/023; H04R 3/12; H04R 1/323; H04R 1/025; H04R 2499/13; B60R 2011/008

(57) ABSTRACT

A headrest assembly for a vehicle includes a frame having a back side and a front side, the frame having a central axis that defines a first portion and a second portion. A motor is mounted to the frame, a first speaker module is disposed at the back side of the frame and operably connected to the motor for movement along the first portion, and a second speaker module is disposed at the back side of the frame and operably connected to the motor for movement along the second portion. The first and second speaker modules each include a housing having a front face with at least one speaker mounted therein for generating audio output. The first and second speaker modules are translatable between a retracted position along the back side of the frame and a deployed position toward the front side of the frame.

### CROSS-REFERENCE TO RELATED APPLICATIONS

This application claims the benefit of U.S. provisional application Ser. No. 63/132,577 filed Dec. 31, 2020, the disclosure of which is hereby incorporated in its entirety by reference herein.

### TECHNICAL FIELD

Embodiments relate to a vehicle headrest assembly with deployable speaker modules.

### BACKGROUND

Modern vehicle systems use a variety of speakers and speaker configurations. Sound quality and performance of vehicle sound systems are an important service of vehicles. In many existing designs, speakers are typically mounted in passenger doors or along a front or rear dash of the vehicle due to spacing and other constraints. There is a desire to improve upon the conventional vehicle configurations of four or five vehicle speakers. While typical vehicle configurations allow for fading sound to the front or back of a vehicle and for panning sound to the left or right side of a vehicle, the overall effect is to limit sound to a particular section of a vehicle from speakers having a fixed position.

Vehicle audio systems are increasingly based on a seat-based concept, which provides individual user-preferred listening modes in each seat. These listening modes rely heavily on the arrangement of headrest speakers, particularly the placement of headrest speakers in relation to the listener's head. Different listening modes require the speakers to be arranged in different positions in relation to the listener's head in order to create the optimal acoustical effect. Other factors, such as safety and comfort, must also be considered.

### SUMMARY

In one or more embodiments, a headrest assembly for a vehicle includes a frame having a back side and a front side, the frame having a central axis that defines a first portion and a second portion. A motor is mounted to the frame, a first speaker module is disposed at the back side of the frame and operably connected to the motor for movement along the first portion, and a second speaker module is disposed at the back side of the frame and operably connected to the motor for movement along the second portion. The first and second speaker modules each include a housing having a front face with at least one speaker mounted therein for generating audio output. The first and second speaker modules are translatable between a retracted position along the back side of the frame and a deployed position toward the front side of the frame.

In one or more embodiments, each of the first and second speaker modules have a proximal portion and a distal portion, the proximal portion including a connecting arm operably connected to the motor and the distal portion including the at least one speaker. Each connecting arm may be operably connected to a rack, and each rack arranged to be engaged by a pinion gear driven by the motor, wherein rotation of the motor in a first direction moves the first and second speaker modules to the deployed position and rotation of the motor in a second direction moves the first and second speaker modules to the retracted position.

In one or more embodiments, in the retracted position, the proximal portion of each of the first and second speaker modules meet at the central axis. In the retracted position, the first and second speaker modules may not extend past the back side of the frame or, alternatively, the first and second speaker modules extend at least partially beyond the back side of the frame. In the deployed position, the first and second speaker modules extend forward past the back side of the frame with the front face of each of the first and second speaker modules oriented inward. The first and second speaker modules may operate in a surround sound audio mode when in the retracted position and operate in an individual sound zone (ISZ) audio mode when in the deployed position. The first and second speaker modules may each include a first speaker and a second speaker, the second speaker having a different frequency range than the first speaker.

In one or more embodiments, a headrest assembly for a vehicle includes a frame having a back side and a front side, the frame having a central axis that defines a first portion and a second portion. A motor is mounted to the frame, a first speaker module is disposed at the back side of the frame and operably connected to the motor for movement along the first portion, and a second speaker module is disposed at the back side of the frame and operably connected to the motor for movement along the second portion. The first and second speaker modules each include a housing having a front face with at least one speaker mounted therein for generating audio output, wherein each of the first and second speaker modules have a proximal portion and a distal portion, the distal portion including the at least one speaker. The first and second speaker modules are translatable between a retracted position along the back side of the frame and a deployed position extending forward past the back side of the frame with the front face of each of the first and second speaker modules oriented inward to provide an individual sound zone audio mode.

In one or more embodiments, an audio system for a vehicle includes at least one headrest assembly including a frame having a back side and a front side, the frame having a central axis that defines a first portion and a second portion. A motor is mounted to the frame, a first speaker module is disposed at the back side of the frame and operably connected to the motor for movement along the first portion, and a second speaker module is disposed at the back side of the frame and operably connected to the motor for movement along the second portion, the first and second speaker modules each including a housing having a front face with at least one speaker mounted therein for generating audio output. The audio system further includes a vehicle control unit in electrical communication with the at least one headrest assembly for translating the first and second speaker modules between a retracted position along the back side of the frame and a deployed position toward the front side of the frame.

In one or more embodiments, the vehicle control unit includes a user interface configured to generate a control signal for movement of the first and second speaker modules in response to user input. The vehicle control unit may be arranged to position the first and second speaker modules based on a vehicle parameter including at least one of vehicle shutdown, vehicle operational mode, occupant detection, or driving condition. The vehicle control unit may control translation of the first and second speaker modules based on a stored user profile.

### BRIEF DESCRIPTION OF THE DRAWINGS

FIG. 1 is a rear perspective of a headrest assembly with speaker modules in a retracted position with respect to the headrest according to one or more embodiments;

FIG. 2 is a rear perspective view of the headrest assembly with speaker modules in a deployed position according to one or more embodiments;

FIG. 3 is a side view of the headrest assembly with speaker modules in a retracted position according to one or more embodiments;

FIG. 4 is a side view of the headrest assembly with speaker modules in a deployed position according to one or more embodiments;

FIG. 5 is a front view of the headrest assembly with speaker modules in a deployed position according to one or more embodiments;

FIG. 6 is a front perspective view of the headrest assembly with speaker modules in a deployed position according to one or more embodiments;

FIG. 7 is a front view illustrating internal components of the headrest assembly according to one or more embodiments;

FIG. 8 is a rear view illustrating internal components of the headrest assembly according to one or more embodiments;

FIG. 9 depicts a process for headrest assembly control according to one or more embodiments;

FIG. 10 depicts a graphical representation of an audio system for a vehicle according to one or more embodiments; and

FIG. 11 depicts a vehicle cabin configuration according to one or more embodiments.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Existing vehicle speaker arrangements cannot simultaneously satisfy all requirements of acoustics, safety, and user comfort while delivering multiple advanced audio features with their optimal performance. To address this challenge, embodiments disclosed herein provide a vehicle headrest assembly with movable speakers which can have a retracted position and a deployed position to offer a plurality of audio modes to the vehicle occupants. These audio modes may include, but are not limited to, Individual Sound Zones (ISZ) mode, binaural mode, and surround sound mode.

In ISZ mode, sound energy is separated from other vehicle seats, thereby producing minimal disturbances for other listeners. In ISZ mode, the best tuning performance may be achieved by placing a speaker or a speaker array on each side of the head in a specific arrangement. In particular, on each side, the speakers may be located at chin level height while staying on the same vertical plane with the ears and tilted in such a way that the main broadcasting direction of speaker points to the chin or mouth of the head of the vehicle occupant. In such an arrangement, the driver's or passenger's head can rotate freely without a blocked view.

In binaural mode, the signals received by the listener's left and right ear are carefully controlled in order to render a three-dimensional sound image in perception for audio effects and immersion and may utilize techniques involving Head Related Transfer Function (HRTF). To achieve a satisfactory binaural rendering effect, a speaker or a speaker array may be placed on each side of the head facing the ears with the same height on the same vertical plane. In this arrangement, speakers produce acoustics around the head with a natural left-right ear cross talk cancellation for mid and high frequencies (>300 Hz), which is advantageous for further application of binaural signal processing techniques. In surround sound mode, speakers are placed near or inside the headrest, behind the listeners head. This arrangement offers comfort and safety and allows unrestricted use for the driver and passengers.

Speakers having a fixed extended position do not allow for selection between different audio modes and suffer from ergonomic, safety, and regulatory issues when realized in the present day automotive environment. For example, speakers in a fixed extended position would prevent people from entering or exiting the vehicle, they can block most of the visual periphery of the occupants, and they may interfere with routine driving tasks. Having speaker modules in the desired locations for optimal performance in different audio modes is simply not feasible without a dynamic, moving solution. Embodiments disclosed herein allow the desired headrest speaker position to be achieved without restricting occupant movement, violating traffic or driving laws, or causing any discomfort to the occupants.

Embodiments disclosed herein provide a headrest assembly for a vehicle which employs speaker modules movable between retracted and deployed positions. The speaker modules utilize motorized, actuator driven, spring driven or manual mechanisms for deployment. Different extended arrangements may be deployed as corresponding audio features and modes are activated, based on the use case. Furthermore, since some audio modes require more precise positioning in the speaker arrangement regarding the listener's head position to account for individual listener seating differences, a vehicle control unit in communication with the headrest assembly may have a memory device to store the user-specific parameters. After the initial adjustment of each user's first activation of each feature, a user profile may be established and can be retrieved in the future.

The disclosed embodiments allow every vehicle seat and associated headrest to be equipped with multiple advanced audio features and modes which can be activated by a vehicle occupant. The disclosed audio system allows a user to access multiple audio features in their optimal performance through different speaker arrangement deployment configurations which account for individual user's seating.

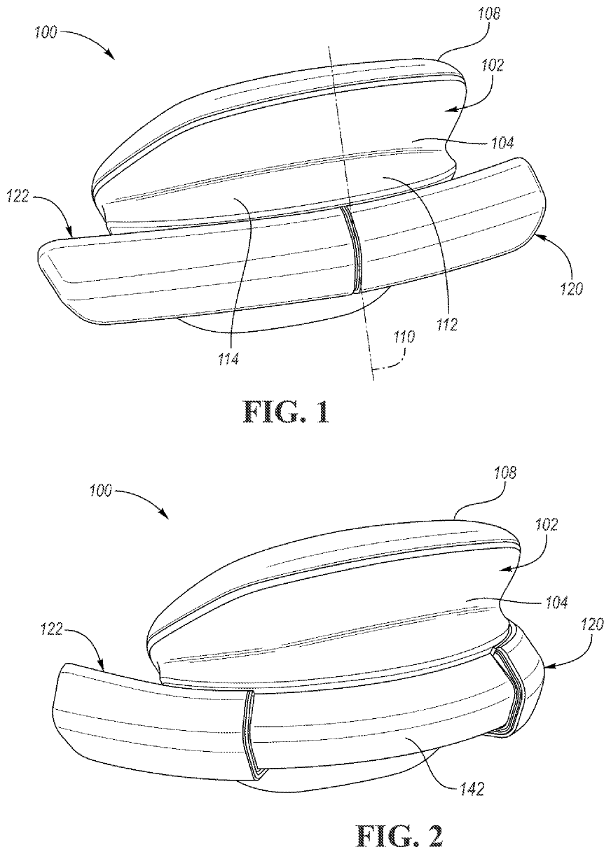

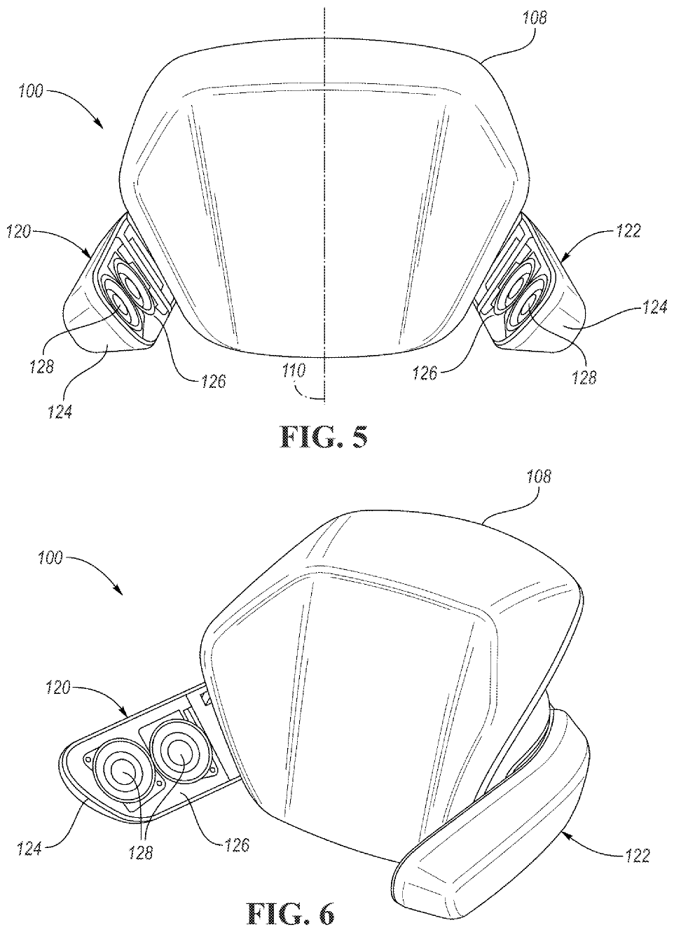

With reference to FIGS. 1-8, a headrest assembly 100 for a vehicle is illustrated according to one or more embodiments. The headrest assembly 100 is arranged to be mounted to a vehicle seat (not shown) or may be a part of the vehicle seat, wherein a plurality of headrest assemblies 100 may be utilized in a given vehicle. The headrest assembly 100 includes a frame 102 having a back side 104 and a front side 106. A head support 108, such as a cushion, may be mounted to the front side 106 of the frame 102. The frame 102 has a central axis 110 that defines a first portion 112 and a second portion 114 of the frame 102, wherein the frame 102 may be constructed from plastic, metal, or another suitable material.

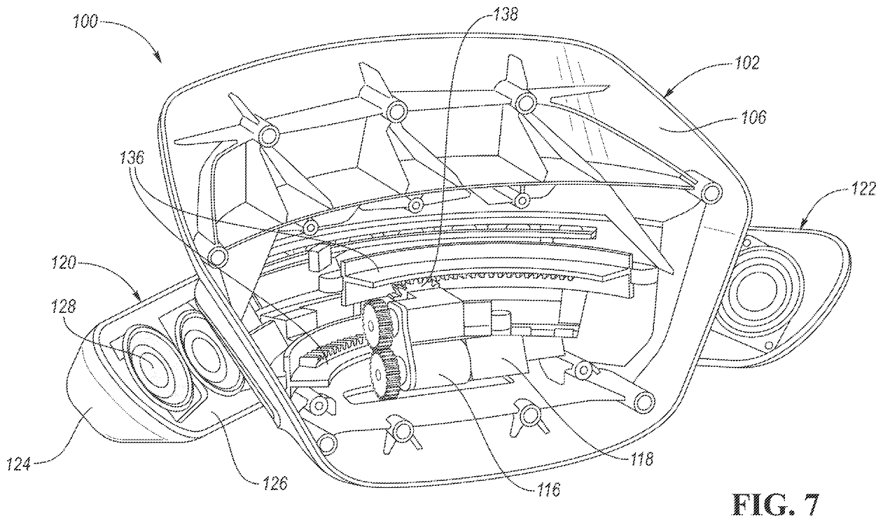

As best shown in FIG. 7, a motor 116 or other suitable actuator may be mounted to the frame 102 in electrical communication with a power source 118, such as associated with the headrest assembly 100 or the vehicle seat. A first speaker module 120 may be disposed at the back side 104 of the frame 102 and operably connected to the motor 116 for movement along the first portion 112, and a second speaker module 122 may be disposed at the back side 104 of the frame 102 and operably connected to the motor 116 for movement along the second portion 114. The first and second speaker modules 120, 122 each include a housing 124 having a front face 126 with at least one speaker 128 mounted therein for generating audio output. In one or more embodiments, the back side 104 of the frame 102, the first speaker module 120, and the second speaker module 122 may each have a curved or convex configuration.

While the speaker modules 120, 122 are shown and described herein as being located on both the first and second portions 112, 114 of the frame 102, it is understood that alternatively only a single speaker module 120, 122 on one of the first portion 112 or second portion 114 could be employed.

The first and second speaker modules 120, 122 are translatable between a retracted position along the back side 104 of the frame 102 and a deployed position toward the front side 106 of the frame 102. As described above, the headrest assembly 100 may employ mechanical actuation of the speaker modules 120, 122 (e.g., motorized, actuator driven, spring driven and/or retraction, etc.) to move the physical orientation of the speaker modules 120, 122 to enable adaptive audio performance. The speaker modules 120, 122 may automatically, electrically, hydraulically, or mechanically be extended, retracted, or tilted along one, two or three axes. While the disclosed embodiments are described as utilizing mechanical operation to retract and deploy the speaker modules 120, 122 with respect to the frame 102, it may be appreciated that one or more embodiments may allow for push button and/or manual (e.g., by hand) translation or other movement of the speaker modules 120, 122.

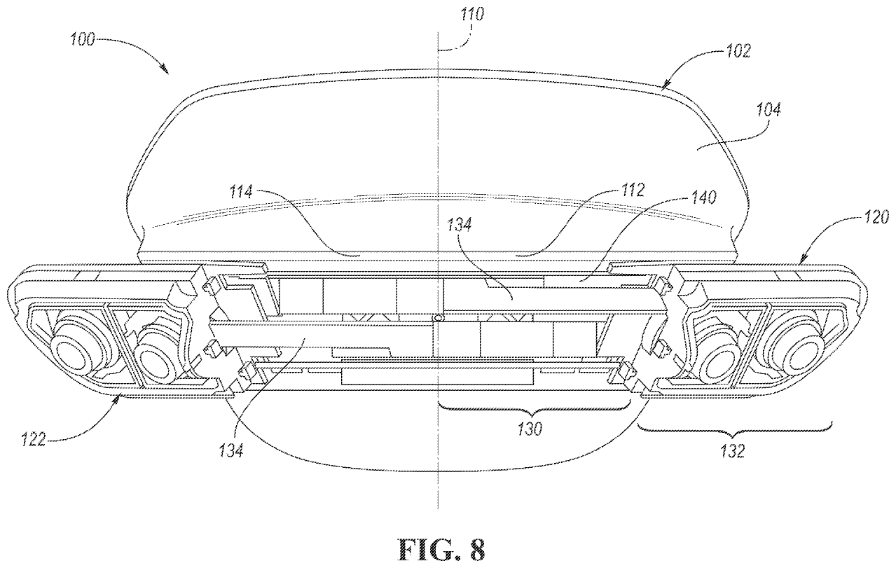

The speaker modules 120, 122 may include one or more arms, linkages, housings, or other mechanical structures that may support and position the speaker modules 120, 122 in the retracted or deployed positions with respect to the frame 102. In one or more embodiments, and as best illustrated in FIGS. 7 and 8, each of the first and second speaker modules 120, 122 have a proximal portion 130 and a distal portion 132, the proximal portion 130 including a connecting arm 134 operably connected to the motor 116, and the distal portion 132 including the one or more speakers 128. Each connecting arm 134 may be operably connected to a rack 136, where each rack 136 is arranged to be engaged by a pinion gear 138 driven by the motor 116. An opening 140 may be provided in the frame 102 through which the first and second speaker modules 120, 122 are operably connected to the motor 116, and a cover 142 (FIGS. 2 and 4) may be mounted to the back side 104 of the frame 102 to house the connecting arms 134 for movement with respect to the opening 140. In one or more embodiments, rotation of the motor 116 in a first direction moves the first and second speaker modules 120, 122 to a deployed position and rotation of the motor 116 in a second direction moves the first and second speaker modules 120, 122 to a retracted position. Of course, the above-described configuration is not intended to be limiting, and other mechanisms for accomplishing movement of the speaker modules 120, 122 are fully contemplated.

The speaker modules 120, 122 may be employed in addition to and/or independently from other vehicle speakers 315 (FIG. 10). A single speaker 128, two speakers 128, or more than two speakers 128 within each speaker module 120, 122 is contemplated. Each speaker 128 may optionally operate with its own sealed acoustic volume so that they do not interfere with each other to the largest possible extent. When two or more speakers 128 are used, the speakers 128 may have different spectral characteristics (frequency ranges). For example, in order to improve the low frequency separation of different sound zones, one of the speakers 128 may be a lower-frequency speaker such as a woofer or a suitable midrange speaker. The other speaker 128 may be a higher-frequency speaker such as a suitable midrange speaker or tweeter. Of course, these configurations are merely exemplary, and the speaker modules 120, 122 are not limited to the housing 124 shape or the number and placement of the speakers 128 shown or described herein. The dimensions of the speaker modules 120, 122 and the number and characteristics of the included speakers 128 may be selected to optimize audio features and performance along with ergonomics for the vehicle occupants.

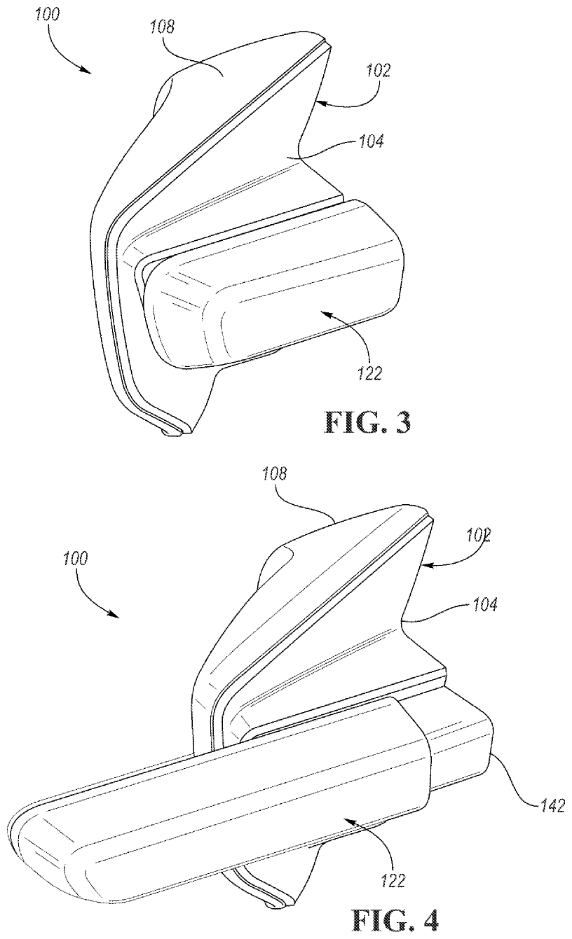

FIGS. 1 and 3 depict a headrest assembly 100 with the speaker modules 120, 122 in a retracted position with respect to the frame 102 according to one or more embodiments. In the retracted position, the speaker modules blend aesthetically with the back side 104. In one or more embodiments, in the retracted position, the proximal portion 130 of each of the first and second speaker modules 120, 122 may meet at the central axis 110 (FIG. 1). In the retracted position, the first and second speaker modules 120, 122 may not extend past the back side 104 of the frame 102, as illustrated in FIG. 3. Alternatively, the first and second speaker modules 120, 122 may extend at least partially beyond the back side 104 of the frame 102 when in the retracted position (FIG. 1).

In the retracted position, the speaker modules 120, 122 may be inactive, or the speaker modules 120, 122 may direct output in at a least a forward direction. The retracted position of the speaker modules 120, 122 with the speakers 128 facing generally forward, and one or more control signals, may allow for a surround sound audio mode. In this surround sound configuration, the speaker modules 120, 122 may be adjacent to the back side 104 or retracted fully behind the back side 104 of the frame 102, firing generally forward, and contributing to the overall sense of space in the vehicle. The retracted position directs speaker output more generally towards the seat occupant and vehicle cabin to provide an acoustic landscape having a larger feel, enhancing the audio experience for all occupants in the vehicle.

FIGS. 2 and 4-6 depict the headrest assembly 100 with the speaker modules 120, 122 in a deployed position with respect to the frame 102 after translational movement according to one or more embodiments. In the deployed position, the speaker modules 120, 122 extend out and forward from the back side 104 of the frame 102 to allow for the speaker modules 120, 122 to be directed towards the occupant's ears. The speaker modules 120, 122 may be arranged to be disposed laterally with respect to the occupant's head, on opposite sides thereof. The speaker modules 120, 122 may be extended forward past the back side 104 of the frame 102 and toward the occupant (away from the frame 102) by translation of the speaker modules 120, 122 with respect to the back side 104 in a horizontal plane, with the front face 126 of each of the speaker modules 120, 122 oriented inward.

The deployed position of the speaker modules 120, 122, and one or more control signals, may allow for an ISZ mode. In the ISZ mode, sound from the speaker modules 120, 122 may have a more direct acoustic transmission path to the occupant's ears. The speaker modules 120, 122 may be located at chin level height while staying on the same vertical plane with the ears and tilted in such a way that the main broadcasting direction of the speaker modules 120, 122 points to the chin or mouth of the vehicle occupant, offering an unobstructed panoramic view for the occupant. The position of the speaker modules 120, 122 may positively influence the amount of passive acoustic isolation or separation between occupants, an important factor in isolation audio configurations. The ISZ mode may deliver more focused audio reproduction to the primary listener's audio playback system, while simultaneously attenuating some of the acoustic energy from other seat's speakers. In certain embodiments, audio may be routed to specific occupants, and the deployed position may allow for one or more occupants to have a dedicated audio output. The ISZ mode may allow for an occupant to listen to a desired audio channel without affecting other occupants in the vehicle.

Although the deployed position shown herein is described as corresponding with an ISZ arrangement and audio mode, other deployed positions are also contemplated. By way of example, the speaker modules 120, 122 could be configured to extend outward from the back side 104 of the frame 102 to allow for the speaker modules 120, 122 to be directed towards occupant ears which, along with one or more control signals, may allow for a binaural mode. In the binaural mode, sound from the speaker modules 120, 122 may be focused towards an occupant's ears, generally in-line with the occupant's ear canal, providing a more direct acoustic transmission path. The speaker modules 120, 122 may be located on each side of the head facing the ears with the same height on the same vertical plane. The position of the speaker modules 120, 122 may positively influence the amount of passive acoustic separation between occupant's left and right ears, an important factor in implementing binaural cross talk cancellation. The binaural mode may utilize techniques involving active cross talk cancellation and Head Related Transfer Function (HRTF), to render a three-dimensional sound image for the occupant to perceive.

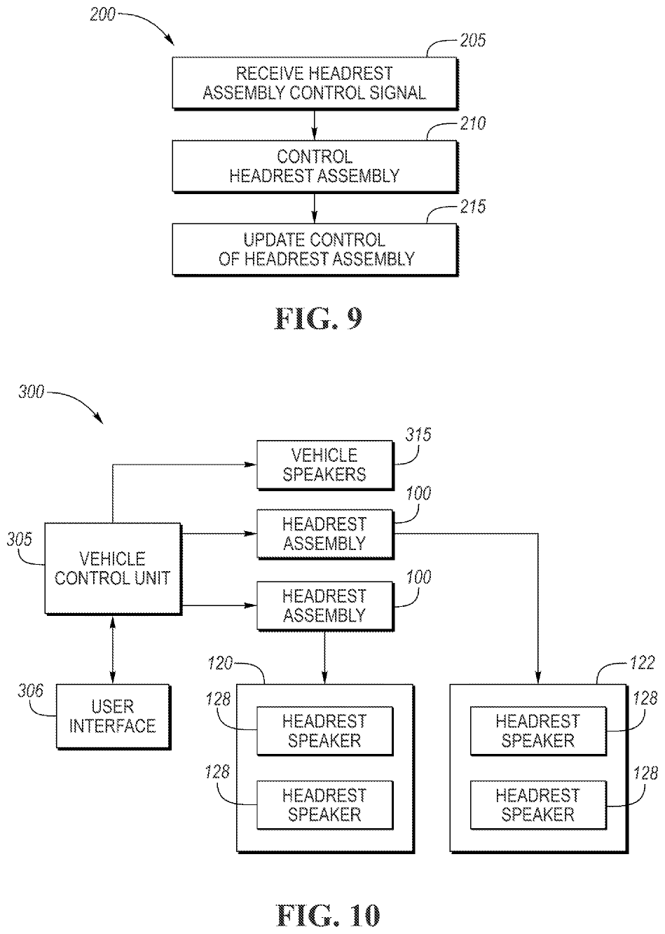

FIG. 9 depicts a process for control of a headrest assembly 100 according to one or more embodiments. Process 200 may be employed by a vehicle control unit 305 (FIG. 10), such as an infotainment unit, head unit, and/or other control unit to control one or more headrest assemblies 100 and headrest elements (e.g., speaker modules 120, 122). Process 200 may be initiated by receiving a headrest assembly control signal at block 205. In one embodiment, headrest assembly control signals may be one or more control signals to direct the position of the speaker modules 120, 122 to at least one of a deployed position and a retracted position. In addition to control of position, headrest assembly control signals may relate to audio data, speaker control, etc. Furthermore, control of speaker module 120, 122 position can be coupled with other seat-based position movements, for example headrest height, seat recline, etc.

At block 210, the headrest assembly 100 may be controlled based on the control signal received at block 205. In one exemplary embodiment, headrest assembly control includes moving the speaker modules 120, 122 from a current position to a second position (e.g., retracted position, deployed position). By way of example, the speaker modules 120, 122 may be controlled to move from a retracted to a deployed position, or vice versa, or between different deployed positions. In some cases, the control signal may be generated by occupant selection of a mode, such as surround sound mode, ISZ mode, or binaural mode, that directs the headrest assembly 100 to control the position of the speaker modules 120, 122. Occupant selections may be detected based on activation of vehicle buttons and/or selections of an infotainment or other user interface 306 (FIG. 10). Although the speaker modules 120, 122 are described herein as moving in a coordinated fashion as a set, independent control and movement of the speaker modules 120, 122 or the movement of only one speaker module 120, 122 are also contemplated.

Controlling can include arranging the speaker modules 120, 122 in one or more of a deployed position and a retracted position. Controlling can include arranging the speaker modules 120, 122 in one or more of a surround sound mode, ISZ mode, and binaural mode. Controlling can include positioning of the speaker modules 120, 122 based on a vehicle parameter including at least one of vehicle shutdown, vehicle operational mode, occupant detection, and/or driving condition. Controlling can include moving the speaker modules 120, 122 automatically between audio modes. Additionally, the position of the speaker modules 120, 122 could be adjusted continuously to enable advanced head-related speaker positioning and tracking.

At block 215, process 200 can update control of the headrest assembly 100 and one or more headrest elements (e.g., speaker modules 120, 122). Process 200 allows for continuous, or regular, monitoring of vehicle control signals such that occupant selections or vehicle events can trigger modifying a position of the speaker modules 120, 122. In one exemplary embodiment, vehicle shutdown or certain operational modes may control the position of the speaker modules 120, 122. For example, shutdown of the vehicle may automatically direct the speaker modules 120, 122 to a retracted position. Alternatively, occupant detection may result in positioning of the speaker modules 120, 122 based on one or more occupant presets. According to another embodiment, driving conditions, such as highway vs. local driving, may prompt the vehicle control unit 305 (FIG. 10) to position the speaker modules 120, 122.

FIG. 10 depicts an audio system 300 according to one or more embodiments. Audio system 300 may relate to a vehicle configuration, such as an automobile or passenger vehicle configuration. According to one embodiment, a vehicle control unit 305, such as a vehicle infotainment unit, is in electrical communication with one or more headrest assemblies 100. The vehicle control unit 305 may provide one or more of driver assistance, navigation, media, and vehicle control features. In one embodiment, the audio system 300 includes a user interface 306 which may be employed to provide one or more commands or control signals to the vehicle control unit 305, including settings for headrest elements (e.g., speaker modules 120, 122). The motor 116 may be in electrical communication with the vehicle control unit 305 and a power source 118 for causing movement of the speaker modules 120, 122. Commands may be directed to one or more of directionality and movable element control as described herein. For example, the vehicle control unit 305 may direct the translation of the first and second speaker modules 120, 122 between a retracted position along the back side 104 of the frame 102 and a deployed position toward the front side 106 of the frame 102. The user interface 306 may include a display and one or more input controls, such as a touch screen display to present a user interface for the vehicle control unit 305 and display of input and adjustment commands.

In one or more embodiments, the vehicle control unit 305 drives one or more vehicle speakers 315. According to another embodiment, the vehicle control unit 305 controls one or more headrest assemblies 100. The headrest assemblies 100 may include one or more speaker modules 120, 122, each including one or more speakers 128, and one or more mechanical elements to position the speaker modules 120, 122. According to another embodiment, the vehicle control unit 305 may be configured to control one or more of the headrest assemblies 100 to allow for one or more adaptive audio modes, such as surround sound mode, ISZ mode, or binaural mode. According to another embodiment, the speakers 128 may operate as a speaker array. The vehicle control unit 305 may be capable of controlling the first speaker module 120 independent from the second speaker module 122. The vehicle control unit 305 may include a processor to perform one or more functions which may be stored in a memory module of the vehicle control unit 305. For example, the vehicle control unit 305 may control translation of the first and second speaker modules 120, 122, such as a certain distance forward of the frame 102, based on a stored user profile.

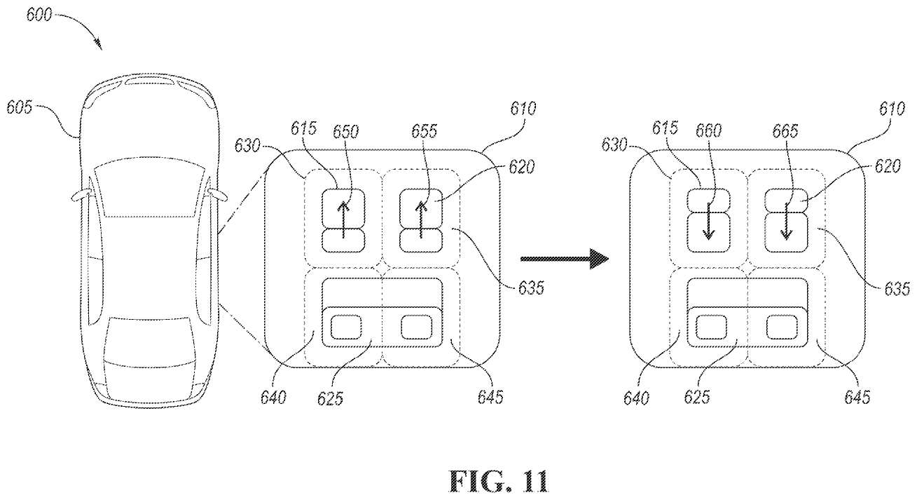

FIG. 11 depicts a vehicle cabin configuration according to one or more embodiments. Vehicle cabin configuration 600 for a vehicle 605 may allow for one or more sound zones and sound configurations. The cabin 610 of the vehicle 605 includes a plurality of seats. According to one embodiment, individual sound zones may be provided by employing configurations of the headrest assembly 100 and speaker modules 120, 122 for vehicle seats. Front seats, such as the driver seat 615 and the passenger seat 620, may each be associated with a dedicated zone. Passenger seats, such as the rear seat 625, may have multiple zones. The rear seat 625 is shown having a two headrest configuration for a bench seat but could be configured with three headrests. A driver zone 630 and a passenger zone 635 are shown for the driver seat 615 and the passenger seat 620, respectively. Each zone relates to an area of the vehicle 605 where sound may be directed and speaker module 120, 122 configurations adaptively controlled to allow for a surround sound, ISZ, or binaural configuration. Rear zones 640 and 645 are shown for the left and right sections of the rear seat 625. As shown in FIG. 11, each seat and zone identified allows for the vehicle headrest assembly 100 to be configured to provide audio output in at least one of the surround sound, ISZ, or binaural configurations.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A speaker assembly for a vehicle configurable to provide different audio modes, the speaker assembly comprising:
a first speaker module operably connected to the headrest for movement with respect to a first portion of the headrest; and
a second speaker module disposed at the back side of the frame and operably connected to the headrest for movement with respect to a second portion of the headrest, the first and second speaker modules each including a housing having a front face with at least one speaker mounted therein for generating audio output,
wherein the first and second speaker modules are translatable along a curvilinear path between a retracted position with respect to the headrest and a deployed position toward a front side of the headrest to provide at least one adaptive audio mode.

2. The speaker assembly of claim 1, wherein each of the first and second speaker modules have a proximal portion and a distal portion, the proximal portion including a connecting arm operably connected to the headrest and the distal portion including the at least one speaker.

3. (canceled)

4. The speaker assembly of claim 2, wherein in the retracted position, the proximal portion of each of the first and second speaker modules meet.

5. The speaker assembly of claim 1, wherein in the retracted position, the first and second speaker modules do not extend past a back side of the headrest.

6. The speaker assembly of claim 1, wherein in the retracted position, the first and second speaker modules extend at least partially beyond a back side of the headrest.

7. The speaker assembly of claim 1, wherein in the deployed position, the first and second speaker modules operate in an individual sound zone (ISZ) audio mode.

8. The speaker assembly of claim 1, wherein the first and second speaker modules operate in a surround sound audio mode when in the retracted position.

9. The speaker assembly of claim 1, wherein the first and second speaker modules each include a first speaker and a second speaker.

10. A speaker assembly for a vehicle configurable to provide different audio modes, the speaker assembly comprising:
a first speaker module disposed at a back side of the headrest and operably connected to the headrest for movement with respect to a first portion of the headrest; and
a second speaker module disposed at the back side of the headrest and operably connected to the headrest for movement with respect to a second portion of the headrest, the first and second speaker modules each including a housing having a front face with at least one speaker mounted therein for generating audio output, wherein each of the first and second speaker modules have a proximal portion and a distal portion, the distal portion including the at least one speaker,
wherein the first and second speaker modules are translatable along a curvilinear path between a retracted position along the back side of the headrest and a deployed position extending forward past the back side of the headrest with the front face of each of the first and second speaker modules oriented to provide at least one adaptive audio mode.

11. The speaker assembly of claim 10, wherein in the deployed position, the first and second speaker modules operate in an individual sound zone (ISZ) audio mode.

12. The speaker assembly of claim 10, wherein in the retracted position, the first and second speaker modules operate in a surround sound audio mode.

13. An audio system for a vehicle configurable in different audio modes, the audio system comprising:
at least one speaker assembly including
a first speaker module operably connected to the headrest for movement with respect to a first portion of the headrest; and
a second speaker module operably connected to the headrest for movement with respect to a second portion of the headrest, the first and second speaker modules each including a housing having a front face with at least one speaker mounted therein for generating audio output; and
a vehicle control unit in electrical communication with the at least one speaker assembly for translating the first and second speaker modules along a curvilinear path between a retracted position with respect to the headrest and a deployed position toward a front side of the headrest to provide at least one adaptive audio mode.

14. The audio system of claim 13, wherein the vehicle control unit includes a user interface configured to generate a control signal for movement of the first and second speaker modules in response to user input.

15. The audio system of claim 13, wherein in the retracted position, the first and second speaker modules do not extend past a back side of the headrest.

16. The audio system of claim 13, wherein in the retracted position, the first and second speaker modules extend at least partially beyond a back side of the headrest.

17. The audio system of claim 13, wherein in the deployed position, the first and second speaker operate in an individual sound zone (ISZ) audio mode.

18. The audio system of claim 13, wherein each of the first and second speaker modules have a proximal portion and a distal portion, the proximal portion including a connecting arm operably connected to the headrest and the distal portion including the at least one speaker.

19. The audio system of claim 13, wherein the vehicle control unit is arranged to position the first and second speaker modules based on a vehicle parameter.

20. The audio system of claim 13, wherein the vehicle control unit controls translation of the first and second speaker modules based on a stored user profile.

21. The audio system of claim 13, wherein the first and second speaker modules operate in a surround sound audio mode when in the retracted position.
